(19) United States
(12) Patent Application Publication
(10) Pub. No.: US 2016/0275598 A1
(43) Pub. Date: Sep. 22, 2016

(54) Methods and Systems for Interactive Internet-based Sales through Video over the Internet

(71) Applicant: The Media Productions Inc., Palo Alto, CA (US)

(72) Inventors: Esther Kestenbaum, Palo Alto, CA (US); Rodney Lee Ghormley, Oneida, WI (US); Paul Kelley, Princeton, NJ (US); Paul Waxlax, Apple Valley, MN (US)

(21) Appl. No.: 15/074,738

(22) Filed: Mar. 18, 2016

Related U.S. Application Data
(60) Provisional application No. 62/136,147, filed on Mar. 20, 2015.

(51) Int. Cl. G06Q 30/06

(52) U.S. Cl. CPC G06Q 30/0643

(57) ABSTRACT

An Internet portal presents content intended for shopping with methods intended to facilitate shopping. The portal presents these contents and methods independent of which Internet-borne medium and which terminal device the user uses to access the portal.

### PRIORITY CLAIM

This application claims priority under 35 U.S.C. Section 119 and 120 to U.S. Provisional Patent Application Ser. No. 62/136,147 filed on Mar. 20, 2015 and titled “Methods for Interactive Internet-based Sales through Video over the Internet,” which is incorporated by reference herein.

### FIELD

This pertains to the field of sales over the Internet in the broadest sense, including but not limited to the world-wide web, mobile broadcast and OTT (over-the-top) broadcast, and IPTV.

### BACKGROUND

A television channel or TV channel is a stream of video data that an entity called a content provider—a combination of persons, computers and other machinery—publishes by transmitting over some medium. This video data comprises a sequence of coherent segments of video called programs. A program is a coherent sequence of information over time, lasting some specific duration, and adapted to be input, used and enjoyed by a human being. A program may be live, pre-recorded, electronically generated, or some combination thereof. Note a program is distinct from a computer program, which is a method to control what a computer does. It is somewhat unfortunate that these terms are easy to conflate. Anyway, content is some set of programs. The content provider provides content.

In general the notions of channels, programs and advertisements have existed for nearly a century, starting with the advent of radio programs. As such these notions are mostly well known and well understood in the art. However, in the context of UBAS their behaviors change subtly from common usage in other venues. As such it is important to define them clearly.

The content provider may publish a TV channel through different media including but not limited to:
over-the-air broadcast television signals—This is the traditional medium of television, where VHF and UHF signals transmit from television towers to antennas that attach to people's television sets. Such transmissions are free and the transmitters earn money from advertisement revenue.
cable television signals—This refers to transmitting television signals over a coaxial copper cable from an aggregator called a head end directly into a television set. This service typically costs the user money.
direct-broadcast satellite television signals—This refers to transmitting television signals from a satellite transmitter to a satellite antenna. A digital decoder decodes this signal and transmits it to a television set. This service costs the user money.
over-the-top internet broadcast—Also called OTT this refers to delivery of video over the Internet without an multiple-system operator (MSO, defined below) controlling the content, even though the internet service provider (ISP) may also be an MSO and/or may be aware of the content. Here accessing the Internet costs this user money, while the terms of receiving the content are entirely decided between the user and the provider of the OTT content; such terms may cost the user money or may be free. This is in contrast with pay television video on demand, where the user pays the ISP to receive some set of programs.
IPTV video service—This refers to the delivery of video where the ISP specifically sells video programs to the user. In contrast to OTT here the ISP controls and distributes the content.
world-wide-web pages or WWW—This refers to web pages that embed video channels. To view that channel the user accesses that webpage. This differs from OTT in that in OTT there is no web page.

To view raw internet content as with OTT, IPTV or WWW the user typically needs to connect the television to the Internet through a set-top box which translates IP packets into a television signal.

An MSO (multi-system operator) is an operator of multiple cable or direct-broadcast satellite television systems. For each such channel in question the MSO receives that channel from a content producer which publishes it, and thereupon retransmits this channel, intending as its recipients a plurality of communities, distinct governmental entities, or some combination thereof. Each such content producer to transmit such a channel engages in its own franchise agreement with the MSO. And each such community or entity to receive such a channel engages in its own franchise agreement with the cable company. Though in the strictest sense any cable company that serves multiple communities is an MSO, the term today is usually reserved for companies that retransmit a large number of such TV channels.

A TV shopping channel is a channel a content producer publishes to show programs about shopping, as opposed to, say, situation comedies or the news. Such shopping programs contain information and enticements about related classes of products and sometimes services, packaged in a way to make sense to would-be shoppers. For instance a shopping program may show Native-American-themed jewelry, such as turquoise earrings, and segue into Native-American-themed apparel such as doeskin moccasin boots. An example purveyor of shopping channels is QVC. exist on television through multi-system operators (MSOs) that broadcast content through cable TV or satellite TV. Upon seeing an item she wishes to purchase the viewer may do so by calling a phone number presented in the video stream of the program, or go visit a website presented in the video stream of the program. Such shows are often published live and may take calls and other feedback as it happens, adding a realness which shoppers typically find pleasing to the experience.

Such shopping channels have been a boon to home shoppers:
Such shoppers can now view and purchase more diverse products and services than they could have had they had to visit a physical store.
Such shoppers do not have to leave the comfort of their own home to do such shopping.

However the shopping channel does have drawbacks including the following:
Today such shopping channels operate exclusively through MSOs. First this means that a given shopping channel can only publish one show at a time, and thus limits buyers to the goods presented in this show.
Users can only view the current content. So the cost of measuring success of the show is in dollars per minute.
When the content provider publishes a live program, the price is high because the content provider must interface to the MSOs through satellite connections. This is very costly.
A TV shopping channel does not allow for individualized selection of items and fields that interest a shopper via personalization.

### The Goal

A more efficient way to publish a shopping channel is through a internet-based platform that retains the advantages of using a TV shopping channel, but eliminates the disadvantages by using the Internet and software programming. We will call this an internet shopping channel or ISC, and the platform that publishes it an internet publishing platform or IPP. More broadly we call the content the IPP publishes internet-based content, or IBC.

The ISC should be independent of the transmission medium. The IPP should be able to publish it through different media including but not limited to OTT, IPTV and WWW. This is so the user can view and use the ISC on a television, a computer or on a handheld smart phone or tablet.

The IPP should be able to publish many different ISCs at the same time.

The IPP should forego all costly satellite links and exclusively use the Internet.

The user should be able to pick which ISCs to view.

The user may view current programming or past programming at will, and to shop accordingly. This makes the dollars-per-minute of airing a channel metric meaningless.

Because IBC is interactive on a personal level, feedback from an individual—both actively as a selection of preferences by that individual, and passively in the form of internet cookies and similar information—allow such a website to tailor its content efficiently for that individual.

But at the same time the user may not necessarily know exactly what she wants. She may only have a vague notion, such as “I need to purchase a present for a four-year-old who is into Legos” or “I want vitamins that will clear up this acne”, without knowing exactly what product she wishes to purchase. Also, she may want to hear suggestions and testimonials from other people like her to see what they think of particular items. So the IPP should provide the user the means to access all of this ancillary classes of content.

### PRIOR ART

Many sales websites, such as Amazon, allow a user to choose exactly what she wants, and even has a search facility. But such websites do not really provide advertisements.

Other websites such as Google provide exact search criteria but not do not necessarily allow a user to purchase things directly.

No single website gathers together a way for a user to specify her exact interests, watch advertisements for goods that match those interests, and then purchase those goods on the fly.

Shopping networks such as QVC provide series of advertisements. But since these publish over conventional television channels the user cannot personalize content. Were a station such as QVC over the internet instead of over conventional TV channels then each user could choose to personalize advertisements to suit her particular requirements. Also, such a channel is controlled at least to some extent by the television signal provider, either in the form of cable or in the form of over-the-air signal. Still, being able to view such channels on a television instead of having to watch them on a computer terminal is preferable to many.

Internet sites exist that project OTT content that a user may view through a set-top box on a TV set. But currently no such site projects OTT content with an effective methodology for presenting and exploiting a shopping channel.

There is a website called pluto.tv that allows the user to choose content that she views over the internet. This website provides content as a set of channels. The user may select a pre-programmed channel to view. Alternately the user has the capability to set filters to view, exclusively or preferentially, content that user has selected. But pluto.tv does not show advertisements. It is not set up to display advertisements, nor to take advantage of advertisements.

U.S. Pat. No. 8,924,261 teaches a website where a user has an avatar that she walks into a virtual shopping area to purchase things.

U.S. patent application No. 13/488,020 teaches a method to allow a user to use a virtual shopping environment via webcam.

U.S. patent application Ser. No. 12/143,953 teaches methods for users to choose advertisements while watching video. But the advertisements themselves are not the video.

U.S. patent application Ser. No. 09/885,794 teaches a system for an interactive television to allow users to choose via an icon on that television screen, how to react to advertisements, including methods to add particular chosen items to a virtual shopping cart for purchase. But this speaks to interactive TV, not the Internet.

Publication WO2001035186B1 teaches an online store for shopping. But it is silent on advertisements.

U.S. Pat. No. 6,954,728 B1 teaches how a user can enter through an interactive television, a virtual world wherein she may select advertisements to show her avatar. But the advertisements are not a free-running stream.

US Patent US20100121710 teaches tailoring online advertisements by geographic location.

U.S. patent application Ser. No. 12/502,818 teaches an interactive checklist for shopping.

U.S. patent application Ser. No. 08/939,338 teaches an online shopping basket.

### SUMMARY OF THE SYSTEM

An IPP publishes a plurality of ISCs. The IPP publishes these over a range of Internet-borne media including:
WWW
OTT
IPTV

Moreover the IPP publishes these ISCs in such a manner that an end user may view them over various Internet client devices including but not limited to:
television sets
computers
tablets
smart phones

The IPP publishes to a given user an interface which allows a user to specify her preferences in a variety of categories. The exact mechanics of this interface varies as a function of which Internet-borne medium the user has chosen to access the IPP.

As a function of those preferences and other considerations the IPP presents a set of ISCs.

Each ISC sequentially shows a series of shopping programs. These shopping programs are similar to, and may be identical to, shopping programs on a TV shopping channel.

While viewing a shopping program the user has options available to her.
The user can use a pause button to pause a program.
The user can use a fast-forward button to fast-forward through a program to see if the contents interest her, at a speed she chooses.
The user can use a rewind button to rewind through a program at a speed she chooses.
The user can use a skip button to skip a program that does not interest her.
The user can use a purchase button to place an order an item in a current program.
The user use a testimonial button to hear testimonials about a particular product.

The functions called out here are not limiting but are exemplary of many other potential functions the IPP may provide.

### BRIEF DESCRIPTION OF THE DRAWINGS

FIG. 1 depicts an embodiment for providing interactive Internet-based sales through video over the Internet.

FIG. 2 depicts the delivery of an exemplary channel from a server to a computing device.

FIG. 3 depicts an exemplary user interface on a computing device.

### THE FIRST EMBODIMENT

### Basic Structure

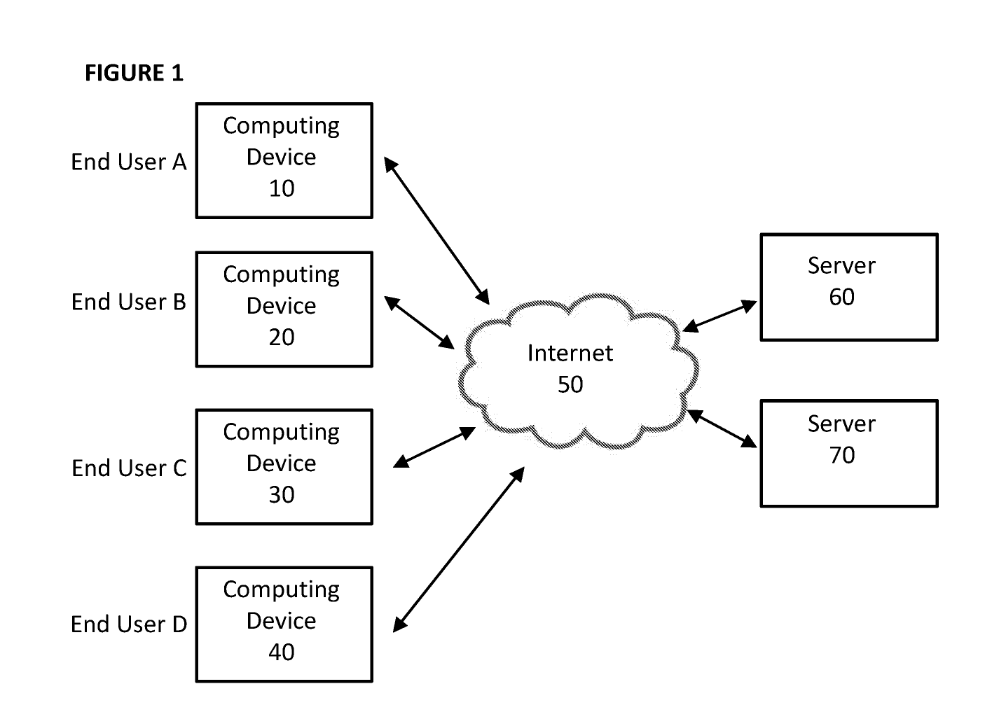

In an embodiment depicted in FIG. 1, an IPP comprises a plurality of computer servers (CS), such as exemplary servers 60 and 70, connected through Internet 50 to each other and also to a plurality of people called end users that access those computer servers through some internet-borne medium including but not limited to WWW, IPTV and OTT. These end users interface using computational devices, such as exemplary computing devices 10, 20, 30, and 40, which can include but is not limited to: computers, tablets, smart phones and television sets.

The interaction between an end user and a CS is largely independent of over which Internet-borne medium the communication occurs, apart from the physical mechanics of the interface device, e.g. a computer has a mouse and keyboard, a smart phone has a touch screen; and the programmatic mechanics of the chosen Internet-borne medium, e.g. WWW uses different button methodologies from OTT.

### Load Balancing

The CS machines, such as servers 60 and 70, load-balance among each other. One CS in the IPP, such as server 60, acts as the initial gateway. When a user accesses the IPP the user initiates communication with the gateway. The gateway communicates with other CS machines and establishes a communication path between some other CS CS1, and the user. This process is well known and well understood in the art, and outside the scope of this disclosure.

### Channels

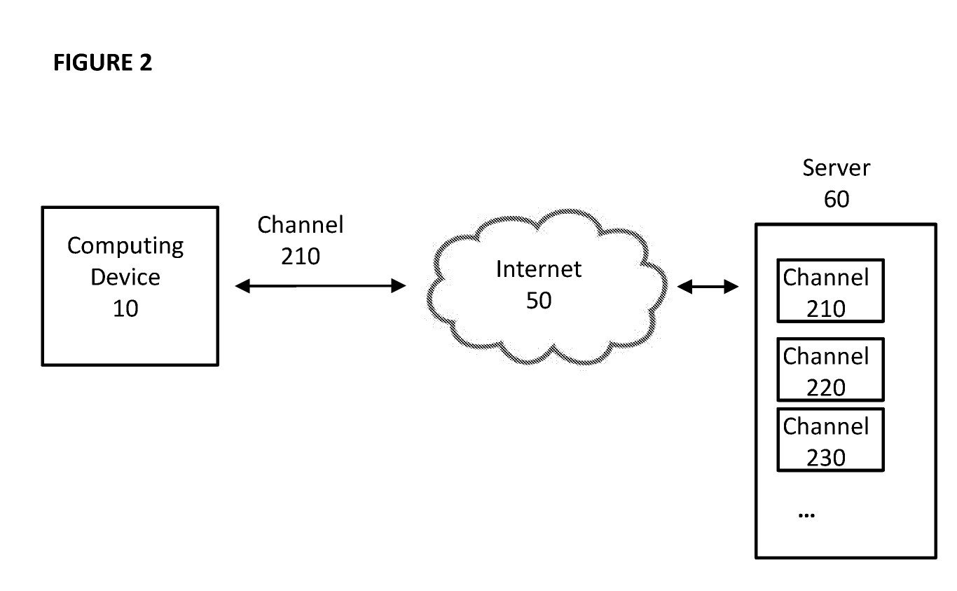

As depicted in FIG. 2, when an end user accesses an UBAS CS by whatever means, the CS, such as server 60, by default presents the end user the option to choose between a set of channels, such as channels 210, 220, 230, and others. If the end user chooses to view a particular channel, such as channel 210, then by default the CS presents to that end user the current content of that channel at the current time. Each channel in a continuous stream of digital video information. At any given moment in time a channel presents a program.

### The Interface

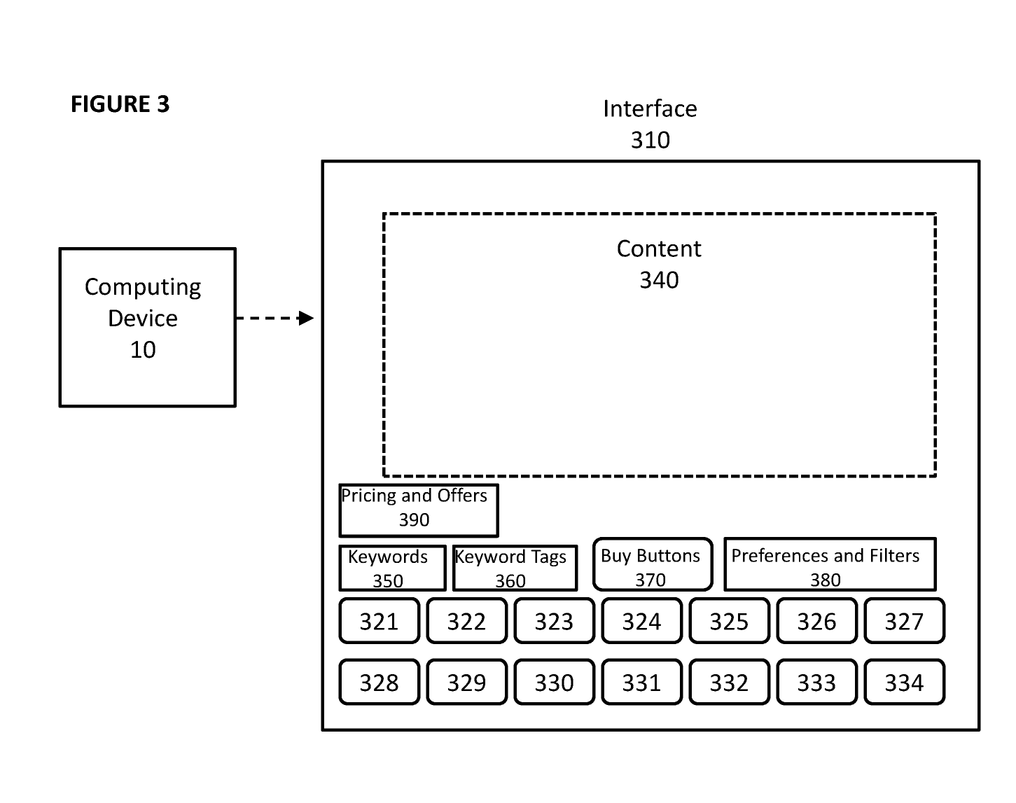

As depicted in FIG. 3, when an end user views a channel then along with the channel programming the end user sees and interacts with a set of control mechanisms. This is called the interface 310. The mechanics of the interface change both with the viewing mechanism such as television, computer, tablet or smart phone; and the Internet-borne medium used such as WWW, OTT or IPTV. However, the functionality of the interface remains the same across all these options.

### Basic Functionality

By default when and end user views a channel that currently has a shopping program playing on it, the interface displays for that channel a set of keywords 350 associated with that channel, and for that program a set of keyword tags 360 associated with that program.

Buy buttons 370 leading to product pages and shopping cart are available alongside as well as integrated into the video content 340.

Dynamic pricing and offers 390 are available integrated into and/or alongside the video content 340.

By default, on a given channel when one program finishes the next one plays. The IPP sequences the programs on the channel according to some computer program, the specifications of the content provider, and/or the wishes of the end user.

The IPP provides on the interface a set of preferences and filters 380. The user can specify in the preferences what tags the user wants to see in programs. Alternately the user can specify using the filters what tags the user does not want to see in programs.

A pause button 321 allows the user to pause in the middle of a program by clicking on it. The user unpauses the program.

A next button 322 allows the user to skip the rest of the current program by clicking on it.

A previous button 323 allows the user to skip to the previous program by clicking on it.

A cache button 324 allows the user to save the current program in a special cache by clicking on it.

A program history button 325 calls up the user's history list by clicking on it.

A purchase button 326 calls up a purchase dialog by clicking on it.

A related button 327 starts a new channel related to the current program.

A channel history button 328 shows what channels the user has viewed. The user can switch to a previous channel.

A new channel button 329 allows the user to start a new channel based on the criteria the user specifies in a dialog page.

A testimonial button 330 allows the user to start a new channel that shows testimonials relating to the product currently on display.

A text chat button 331 allows the user to start a chat page with a live operator.

A live chat button 332 allows the user to start a voice chat with a live operator.

A social media button 333 allows the user to post live comments during programs to social media such as facebook and twitter.

A loyalty point system 334 provides one point of loyalty for each hour the user has watched videos.

This embodiment provides the user of a computing device with a choice of video channels over the Internet. Each channel contains video programs, and within each program, the user is provided with numerous interactive features, including the ability to purchase items related to the program.

What is claimed is:

1. A method of providing a channel of video content and a purchasing option over the Internet, comprising:
receiving, by a server, a selection from a computing device over the Internet for a channel of video content;
providing, by the server, the channel of video content to the computing device over the Internet;
providing in a user interface, by the server, an input device allowing a user to specify preferences or filters;
dynamically selecting, by the server, a program to send in the channel to the computing device based on the preferences or filters; and
providing in the user interface a purchasing option for a product, wherein the product is selected by the server based on the video content.

2. The method of claim 1, further comprising:
receiving, by the server, an instruction from the computing device to execute a purchase of the product.

3. The method of claim 1, wherein the purchasing option comprises a price set dynamically by the server for the product.

4. The method of claim 1, further comprising:
providing in the user interface an input device to pause the video content.

5. The method of claim 1, further comprising:
providing in the user interface an input device to skip to a next program within the video content.

6. The method of claim 1, further comprising:
providing in the user interface an input device to skip to a previous program within the video content.

7. The method of claim 1, further comprising:
providing in the user interface an input device to save a program within the video content.

8. The method of claim 1, further comprising:
providing in the user interface an input device to request a history of programs viewed on the computing device.

9. The method of claim 1, further comprising:
providing in the user interface an input device to start a new channel related to the current program.

10. The method of claim 1, further comprising:
providing in the user interface an input device to start a new channel based on criteria specified by the computing device.

11. A server for providing a channel of video content and a purchasing option over the Internet to a computing device, the server configured to execute instructions for:
receiving, by the server, a selection from a computing device over the Internet for a channel of video content;
providing, by the server, the channel of video content to the computing device over the Internet;
providing in a user interface, by the server, an input device allowing a user to specify preferences or filters;
dynamically selecting, by the server, a program to send in the channel to the computing device based on the preferences or filters; and
providing in the user interface a purchasing option for a product, wherein the product is selected by the server based on the video content.

12. The server of claim 11, wherein the server is further configured to execute instructions for:
receiving, by the server, an instruction from the computing device to execute a purchase of the product.

13. The server of claim 11, wherein the purchasing option comprises a price set dynamically by the server for the product.

14. The server of claim 11, wherein the server is further configured to execute instructions for:
providing in the user interface an input device to pause the video content.

15. The server of claim 11, wherein the server is further configured to execute instructions for:
providing in the user interface an input device to skip to a next program within the video content.

16. The server of claim 11, wherein the server is further configured to execute instructions for:
providing in the user interface an input device to skip to a previous program within the video content.

17. The server of claim 11, wherein the server is further configured to execute instructions for:
providing in the user interface an input device to save a program within the video content.

18. The server of claim 11, wherein the server is further configured to execute instructions for:
providing in the user interface an input device to request a history of programs viewed on the computing device.

19. The server of claim 11, wherein the server is further configured to execute instructions for:
providing in the user interface an input device to start a new channel related to the current program.

20. The server of claim 11, wherein the server is further configured to execute instructions for:
providing in the user interface an input device to start a new channel based on criteria specified by the computing device.
